(19) United States
(12) Patent Application Publication
(10) Pub. No.: US 2016/0245042 A1
(43) Pub. Date: Aug. 25, 2016

(54) FLUOROPOLYMER ARTICLE FOR DOWNHOLE APPLICATIONS

(71) Applicant: W. L. Gore & Associates, Inc., Newark, DE (US)

(72) Inventors: William Joseph Napier, Millersville, PA (US); Gary P. Harp, Newark, DE (US)

(21) Appl. No.: 15/049,504

(22) Filed: Feb. 22, 2016

Related U.S. Application Data
(60) Provisional application No. 62/119,329, filed on Feb. 23, 2015.

(51) Int. Cl. E21B 34/06; B32B 27/32; B32B 3/26; E21B 43/12

(52) U.S. Cl. CPC E21B 34/06; E21B 43/128; B32B 27/322; B32B 3/26; B32B 2435/00

(57) ABSTRACT

A check valve for down-hole drilling applications may include a housing having a vent port and a chamber within the housing. The check valve may include a displaceable member within the chamber of the housing. An expanded polytetrafluoroethylene (ePTFE) membrane may be disposed over the vent port to protect the check valve from corrosion.

### CROSS-REFERENCE TO RELATED APPLICATIONS

This non-provisional application claims priority to U.S. Provisional Application Ser. No. 62/119,329, titled “Fluoropolymer Article for Downhole Applications,” and filed on Feb. 23, 2015, the entirety of which is incorporated herein by reference.

### FIELD

The present disclosure relates generally to downhole exploration and production, and more specifically to a filtration article that meets corrosion and contamination requirements of an electric submersible pump (ESP).

### BACKGROUND

In downhole drilling applications, such as oil and gas exploration, pipes and wells extend under the seabed to look for and extract natural resources such as hydrocarbons. Various equipment and tools are used to detect and extract the resources. An ESP (electrical submersible pump) as described in American Petroleum Institute publication RP 11S (Recommended Practice for the Operation, Maintenance and Troubleshooting of Electric Submersible Pump Installations) is an example of such equipment. Environmental conditions at the depths of 10,000-15,000 feet and harsh locations such as arctic Russia to which these pipes and wells extend are severe. Temperatures can exceed 260° C., and fluid present include a mixture of water, salts, corrosive chemicals (H₂S and CO₂), and particulate matter that can interfere with the operation of the ESPs. During the service life of an ESP it is common for the tool to travel from the surface to various depths in the well resulting in a need to equilibrate the internal pressure in the tool to the external pressure of the well.

To protect the equipment, “protector” or “seal” sections are used in ESPs. These protector sections usually include labyrinths, bladders, check valves (also called relief valves), and vent ports. A typical bladder is an elastomeric bag filled with hydraulic oil. The volume of oil increases due to heating. When the volume of hydraulic oil exceeds the available volume in the protector section, the oil is released into the well fluids through an orifice or orifices. To limit ingress of dirty or corrosive fluid into the tool, one or multiple spring loaded check valves are often employed. When a sufficient volume of oil is released, the pressure is equalized, and the check valve seals. With known designs, there is a risk of ingress of water and particle contaminants into the check valve. Ingress of these materials ultimately leads to corrosion of the valve and failure of the protector section, risking damage to the ESP and shutdown of the operation for repairs and replacement. One common failure mode is ingress of high salinity water through the check and protector bag into the motor windings causing short circuits and ultimately catastrophic motor failure.

Better protection for the ESP, its check valves and other equipment in extreme conditions such as downhole drilling applications due to water and particulate ingress is desirable. Durable pressure equalization between liquids at high hydrostatic pressures is also desired.

### SUMMARY

One embodiment of the disclosure relates to a check valve for down-hole drilling applications comprising housing having a vent port; a chamber within said housing; a displaceable member within said chamber; and an expanded polytetrafluoroethylene (ePTFE) membrane disposed over said vent port to protect said check valve from corrosion. The ePTFE membrane is preferably asymmetric.

A second embodiment of this disclosure relates to an electric submersible pump for down-hole drilling applications comprising a protector section having a check valve comprising a housing having a vent port; a chamber within said housing; a displaceable member within said chamber; and an ePTFE membrane disposed over said vent port to protect said check valve from corrosion.

A third embodiment of this disclosure relates to a method of protecting from corrosion in a down-hole drilling application a check valve having a housing having a vent port, a chamber within the housing, and a displaceable member within the chamber, the method comprising disposing over said vent port an asymmetric ePTFE membrane.

A fourth embodiment of this disclosure relates to a method of equalizing pressure between two liquid media at high hydrostatic pressure comprising the step of disposing an ePTFE membrane between said liquids.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a schematic illustration of downhole drilling;

FIG. 2a is a side view of a protector section of a downhole drilling operation;

FIG. 2b is a cross section of a protector section of a downhole drilling operation;

FIG. 3 is a side view of a seal section of protector section of a downhole drilling operation;

FIG. 4a is a cross section of a check valve with check valve in the open position;

FIG. 4b is a cross section of a check valve with a check valve in the closed position;

FIG. 5a is a cross section of an exemplary embodiment of this disclosure with a check valve in the open position;

FIG. 5b is a cross section of an exemplary embodiment of this disclosure with the check valve in the closed position;

FIG. 5c is a perspective view of an exemplary embodiment of this disclosure;

FIG. 5d is a schematic cross section of an exemplary embodiment of this disclosure;

FIG. 6 is a photograph of oil used to test the present disclosure;

FIG. 7 is a photograph of an oil and saltwater mixture used to test the present disclosure;

FIG. 8 is a photograph of the oil and saltwater mixture after being filtered through an embodiment of the present disclosure;

FIG. 9-11 are photographs of metal used to test the present disclosure;

FIG. 12 is a schematic of the filtration experiment;

FIG. 13 is a photograph of the corrosion test;

FIG. 14 is a schematic of the corrosion test.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

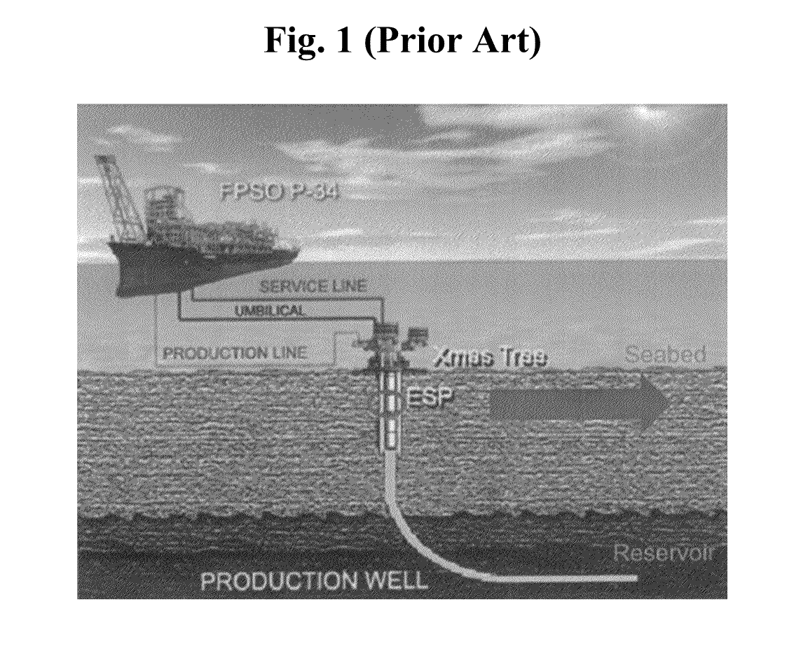

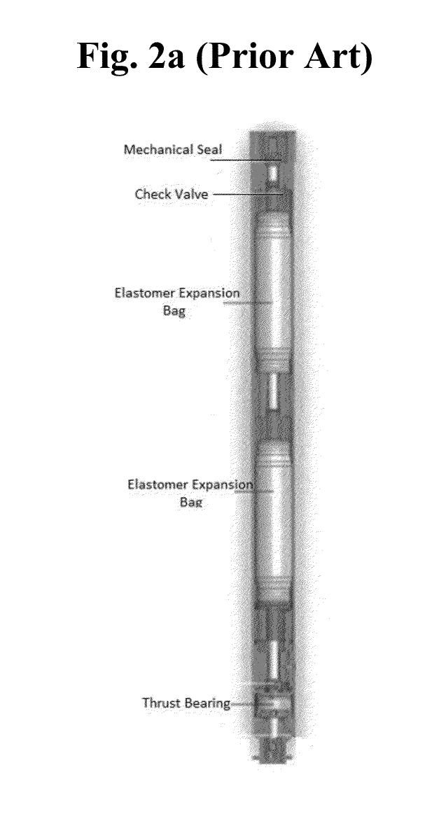

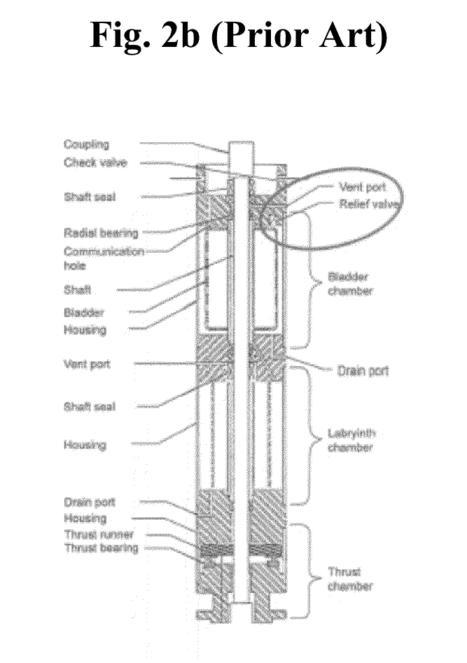

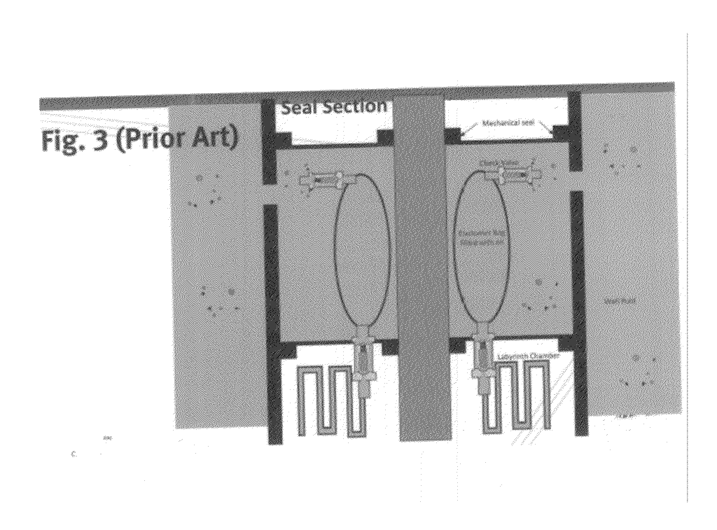

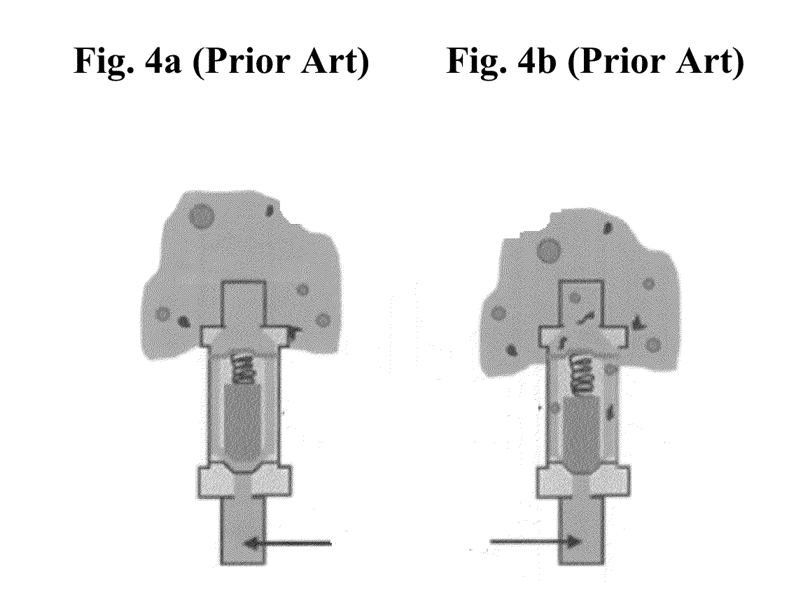

FIG. 1 shows a schematic of a downhole oil and gas mining operation. An ESP is commonly used in connection with such operations, particularly when horizontal drilling is involved, as shown. FIG. 2a illustrates a typical protector section used in operations to adjust for pressure differentials downhole. FIG. 2b provides more detail of such a protector section. FIG. 3 is an enlarged view of the seal section of a protector section, such as the protector section of FIG. 2b. The check valve as illustrated in FIGS. 3 and 4a allows high pressure oil within the bladder to burp out in order to equalize the pressure between the oil within the bag and the well fluid outside the bag (both of which are under high hydrostatic pressure). As shown in FIG. 4b, however, when the check valve returns to its closed position after pressure equalization the valve is exposed to contamination by ingress of water and particulates into the check valve.

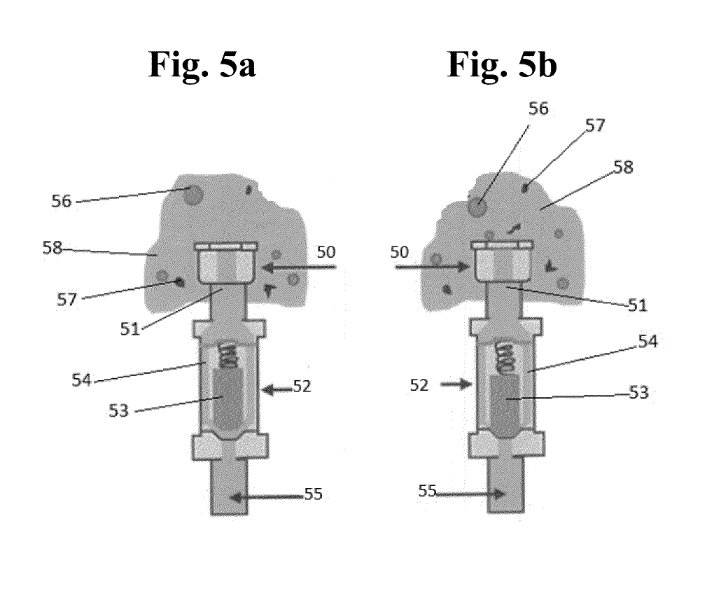

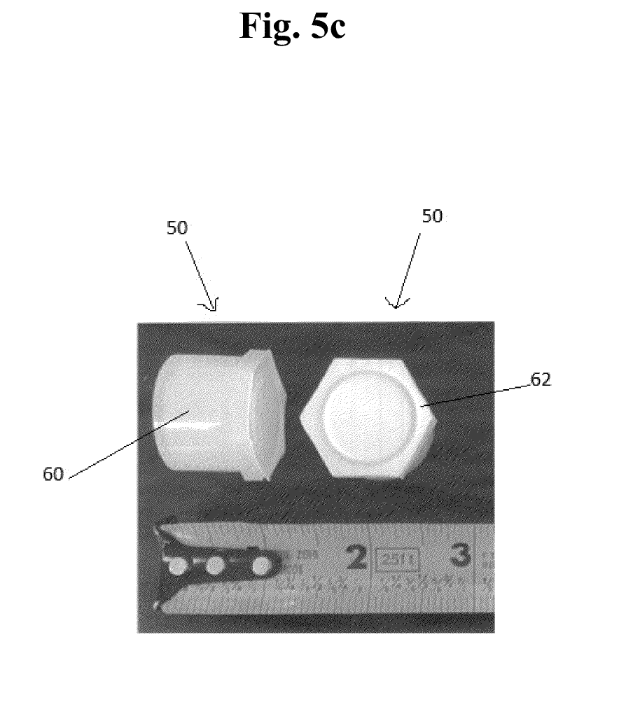

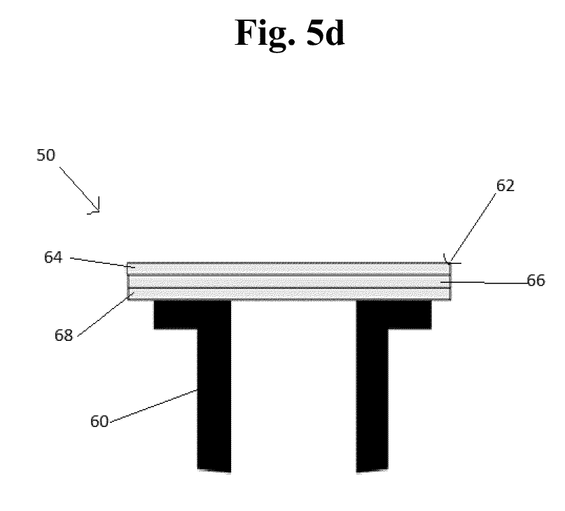

An exemplary embodiment of the present disclosure is shown in FIGS. 5a-5b. In the illustrated embodiment, a cap 50 is attached to the vent port 51 of the check valve 52. As shown in FIG. 5a a displaceable member 53 is positioned within a chamber 54 of the housing of the check valve 52. When the displaceable member 53 is positioned such that the check valve 52 is open, oil 55 (under hydrostatic pressure) may enter the chamber 54 of the check valve 52, pass through the cap 50, and enter the ESP. As shown in FIG. 5b, when the displaceable member 53 is positioned such that the check valve 52 is in a closed position, the cap 50 can prevent water 56 and particles 57 of the well fluid 58 from entering the chamber 54 of the check valve 52. The cap 50 can reduce damage to the check valve 52 by preventing the ingress of water 56 and/or particulates 57 from entering the check valve 52. In other words, the cap 50 can prevent water 56 and in some aspects particulates 57 from the well fluid 58 from mixing with and contaminating the oil 55 present within the check valve 52. The cap 50 can also allow the oil 55 to pass through the cap 50 and enter the ESP.

FIG. 5c shows a perspective view of an exemplary embodiment of the cap 50. The cap 50 can include a base 60 and a filter membrane 62. The base 60 can comprise a fluoropolymer material such as PFA, though other suitable materials may be used. The filter membrane 62 can comprise one or more membrane layers, the membrane layers may comprise a fluoropolymer membrane. In some aspects, the filter membrane 62 may also include a support layer. The filter membrane 62 can be bonded to the base 60, as described further below in the Examples.

A cross-sectional view of an embodiment of the cap 50 is shown in FIG. 5d. The filter membrane 62 of cap 50 can include a first membrane layer 64, a second membrane layer 66, and a support layer 68. In some embodiments, only a single membrane layer may be used. In some embodiments the support layer 68 may be positioned proximate to the first membrane layer 64. The first membrane layer 64 and the second membrane layer 66 can each comprise a fluoropolymer membrane, for example expanded polytetrafluoroethylene (ePTFE). The first membrane layer 64 may have a different porosity than that of the second membrane layer 66, rendering the composite membrane of the filter membrane 62 asymmetric. For example, the first membrane layer 64 may have a porosity that is greater than that of the second membrane layer 66. Bubble point may be used to measure the pore size or porosity of the first membrane layer 64 and second membrane layer 66. In some embodiments, the first membrane layer 64 may have a bubble point of between approximately 3 psi and approximately 10 psi and the second membrane layer may have a bubble point of between approximately 20 psi and approximately 80 psi. In one example, the first membrane layer 64 may have a bubble point of approximately 5 psi and the bubble point of the second membrane layer 66 may be 60 psi. The porosity of the first membrane layer 64 and the second membrane layer 66 can be sufficiently small to prevent water and/or particulates from passing through one or both of the first membrane layer 64 and the second membrane layer 66. Thus, alone or in combination the first and second membrane layers 64, 66 can filter water and/or particulates from passing through the filter membrane 62 and entering the check valve. The porosity of the first membrane layer 64 and the membrane filter layer 66 can be sufficiently large to allow oil to pass through the filter membrane 62 and enter the ESP.

In embodiments that include a support layer 68, the support layer 68 can a PFA woven support layer, a PTFE woven support layer, a fluoropolymer nonwoven support layer, or a metal frit support layer. The support layer 68 can comprise a material that can aid in the bonding of the filter membrane 62 to the base 60. In some embodiments, the second membrane layer 66 can be bonded directed to the base 60 and the additional support layer 68 may not be used. In other embodiments the support layer 68 may be positioned proximate to the first membrane layer 64.

In some embodiments, the cap 50 can comprise a filter membrane 62 that includes a first membrane layer and a second membrane layer without a support layer. In such embodiments, the second membrane layer can be bonded directly to the base. One or both of the first membrane layer and the second membrane layer can have a porosity that is sufficiently small so as to filter and prevent water and/or particulates from passing through the cap 50 while allowing oil to pass through. In some embodiments, the filter membrane 62 may only include a single membrane layer with or without a support layer. In some embodiments, the support layer may also provide some filtering properties in addition to providing support. The cap 50 is small in size and is lightweight without sacrificing a high flow. In some aspects, the filter membrane 62 may be directly adhered or positioned on the vent port of the check valve without the use of a base 60. Exemplary materials for the cap 50 may be found, for example in U.S. patent application Ser. No. 14/570,175, which is incorporated herein by reference in its entirety.

### EXAMPLES

### Test Methods

### Example 1

An expanded polytetrafluoroethylene (ePTFE) composite with was produced by co-expanding the layers together such that layer was situated in between two cover layers. The mass, isopropanol bubble point, air flow, thickness, density, and porosity of the resultant composite were measured to be 181 g/m², 62.6 psi, 3.6 Gurley seconds, 629 micrometers, 0.29 g/cm³, and 86.9% respectively.

A PFA pipe coupling was obtained from McMaster-Carr (part number 45505K138). The pipe coupling was cut in half perpendicular to the threading axis. The cut was made on the hexagonal portion of the PFA coupling and polished flat to create two PFA caps. The PFA cap has ½″ NPT threads on one side and a polished PFA face on the other. A 0.095-inch ledge was cut 0.100 inches deep into the polished PFA face. A PFA support was press fit into the ledge. The PFA support was machined from ¾ inch diameter bar stock (McMaster-Carr catalog number 85555K26) to be 0.750 inches in diameter, and 0.100 inches thick. Thirteen 0.125 inch holes were drilled through the support. The first hole is located in the center of the part, the others offset by 60 degrees with center spacings of 0.160 inches. The press fit support allowed the membrane to be supported across the inner diameter of the PFA part while the thirteen holes allowed flow. Next, the membrane was attached to the base of a PFA cap through an attachment weld. The attachment weld was created by heat staking using a Sonitek TS500 with the following settings: heat stake temperature of 698° F. (370° C.), a dwell time of 60 seconds, and an input pressure setting of 20 psi. The heat stake had an OD of 0.945 inches (24.0 mm) and an ID of 0.846 inches (21.5 mm) and was constructed from chromium copper alloy 184. A layer of 0.002-inch Kapton film was used between the membrane and the heated copper stake during the attachment process.

The final part characteristics are: 0.905 inches in height with a 1.120 inch cylindrical base housing female ½″ female NPT threads. The membrane attachment weld had an OD of 0.945 inches (24.0 mm) and an ID of 0.846 inches (21.5 mm), centered on the center axis of the PFA part. A 0.650 inch hexagonal, 0.100 inch height portion above the base allows the cap to be manipulated by an adjustable wrench. The air permeability of this part was measured at 5.44 standard liters per minute per psi. The airflow test was conducted using an Aalborg GFC37 mass flow controller to flow air at set flow rates through a pressure gauge and the cap. An Omega Engineering Berlium Copper Diaphragm Brass Socket 0-160 inches of water pressure gauge was used to measure the air pressure immediately upstream of the cap. Several airflow and corresponding pressure points were measured. A linear regression was used to determine the permeability. The water entry pressure was measured at 45.2 psi. The water entry pressure (WEP) was measured by filling the interior of the cap with water, then pressurizing air behind the water column. The air pressure is increased until one visually detects water passing through the membrane. The pressure at this point is the WEP. The cap is shown in FIG. 5b.

50 g of NaCL obtained from Sigma-Aldrich (Trace Analysis grade, >99.999% (metals basis), part number 38979-100G-F) was added to 500 g of DI water (measured resistivity of 18.2 MΩ/cm) to create a saline solution. The solution was created in a 1.5-liter beaker (VWR Griffin Low Form Beakers with Double-Capacity Scale, Borosilicate Glass, catalog number 89000-214). This solution was heated to 70° C. and stirred with a 1.5 inch×0.5 inch octagonal Teflon coated stir bar (VWR Spinbar, catalog number 58947-138) at 300 RPM on a Thermo Scientrific Super-Nuova Single-Position Digital Stirring Hotplate (catalog # SP131825Q) until the salt was fully visibly dissolved.

800 mL of Davley Darmex RPL-575 High Temperature Oil was heated to 70° C. on a Thermo Scientrific Super-Nuova Single-Position Digital Stirring Hotplate (catalog # SP131825Q) and stirred with a 3 inch×0.5 inch octagonal Teflon coated stir bar (VWR catalog number 80062-078) at 700 RPM in a 2 liter beaker (VWR Griffin Low Form Beakers with Double-Capacity Scale, Borosilicate Glass, catalog number 89000-216). 79 mL of the saline solution was added to the oil. The oil/saltwater mixture continued to be stirred at 700 RPM. The emulsion was visually turbid throughout the volume before beginning filtration.

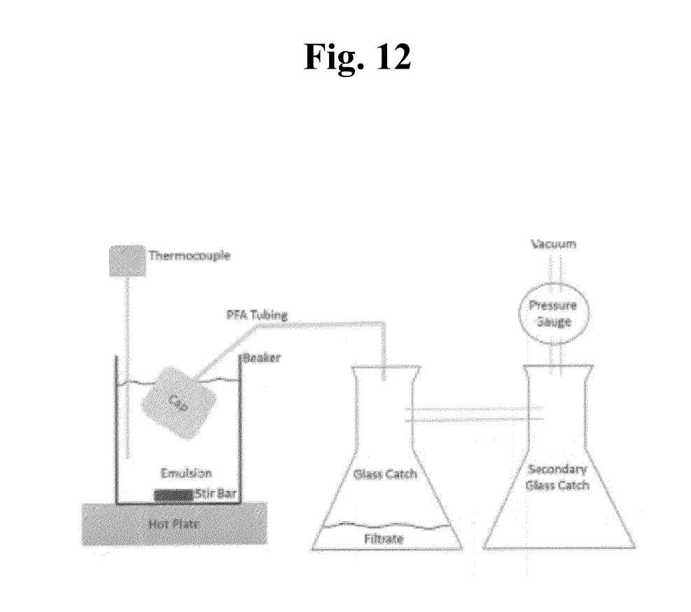

PFA tubing connected the cap to a glass catch. The glass catch was connected to a secondary glass catch. The secondary glass catch was connected to a vacuum line. The vacuum line was connected to a pressure gauge. The cap was submerged into the emulsion at an angle (approximately 30 degrees from vertical) and allowed to come to thermal equilibrium. The temperature of the emulsion was verified using a thermocouple. A vacuum was generated, which drew liquid through the membrane in the cap and into the glass catch. The filtrate can then be collected after the experiment. The glass catch and the secondary glass catch were both Kimax graduated filtering flasks (part number 27060-1000). A Omega Engineering type K thermocouple was used to measure temperature. The pressure gauge was a Marsh 0-30 inches mercury vacuum gage (Marsh Bellofram part number P0505). This filtration setup is shown in FIG. 12. The vacuum was set at 20 inches of mercury, and 170 mL of filtrate was collected.

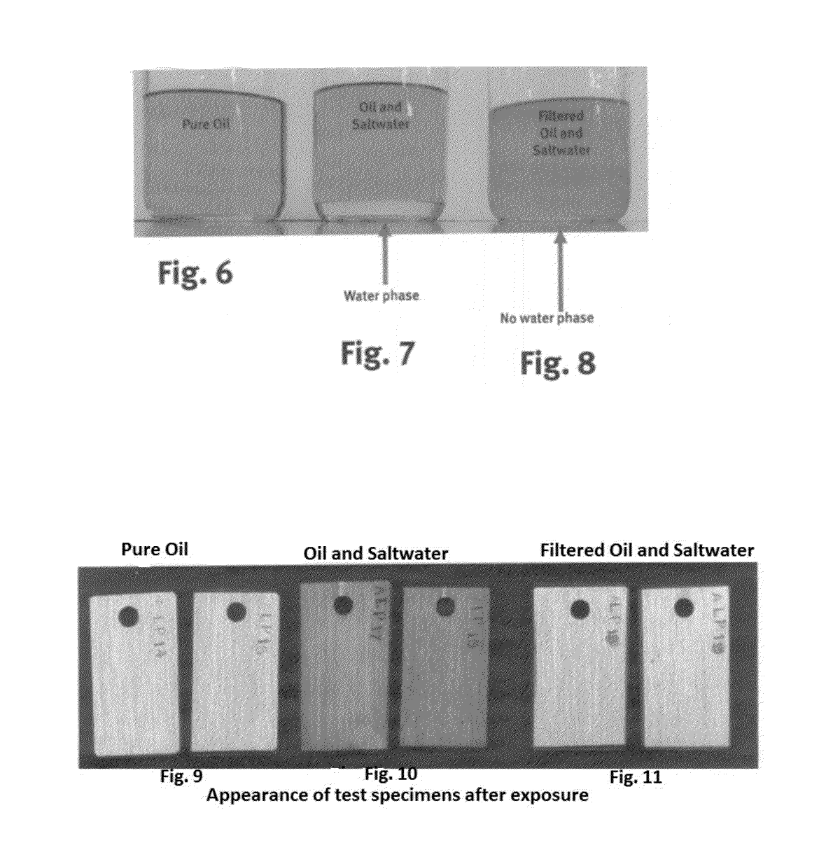

This filtration procedure (paragraph 00028 and 00029) was repeated twice more, until 510 mL of filtrate total was collected. From this, 500 mL of filtrate was sealed in a glass jar with PTFE-line polypropylene closures (I-CHEM Certified 300 Series, Clear, VWR catalog number IRV320-0500) shown in FIG. 8. 500 mL of saltwater/oil emulsion (created using the same procedure as above) was sealed in a glass jar with PTFE-line polypropylene closures (I-CHEM Certified 300 Series, Clear, VWR catalog number IRV320-0500). When allowed to rest, the emulsion separated into a water phase and an oil phase, shown in FIG. 7. 500 mL of pure Davley Darmex hydraulic oil sealed in a glass jar with PTFE-line polypropylene closures (I-CHEM Certified 300 Series, Clear, VWR catalog number IRV320-0500) is shown in FIG. 6.

These three 500 mL samples were sent to Corrosion Testing Laboratories (CTL), 60 Blue Hen Drive, Newark, Del. 19713 USA. CTL preformed corrosion testing using the pure oil, unfiltered saltwater/oil mixture, and filtered saltwater/oil mixture. Duplicate test specimens of 410 SS were exposed by total immersion in each of the three fluids at 140° C. for one week. Due to the temperature, the tests were performed in glass lined pressure vessels to prevent water loss during the test. Each test vessels was purged with carbon dioxide prior to sealing. Agitation was maintained by a magnetic stirrer placed in the bottom of the test vessel. After exposure, the test specimens were evaluated for corrosion rates based on mass loss and for localized corrosion based on visual examination. The test methods used followed the guidelines of ASTM G 1, Standard Practice for Preparing, Cleaning, and Evaluating Corrosion Test Specimens, and ASTM G 31, Standard Practice for Laboratory Immersion Corrosion Testing of Metals.

Test specimens were prepared from type 410 SS sheet. 410 SS was supplied from Metal Samples Company, 152 Metal Samples Road Munford, Ala. 36268 USA. Chemical properties (%): C: 0.145, Cr 11.860, Cu: 0.060, Fe: Balance, Mn: 0.430, Mo: 0.050, N: 0.013, Ni: 0.130, P: 0.015, S: 0.001, Si: 0.360. Physical properties: Tensile—72,500 psi, Elongation—32.0%, Yield—37,300 psi, Hardness—RB 77. Each test specimen measured approximately ½-inch wide by 1-inch long and ⅛-inch thick with a ⅛-inch diameter hole at one end. The test specimens were uniformly finished using 120-grit abrasive paper on all surfaces. A unique identification was stamped on one face of each test specimen.

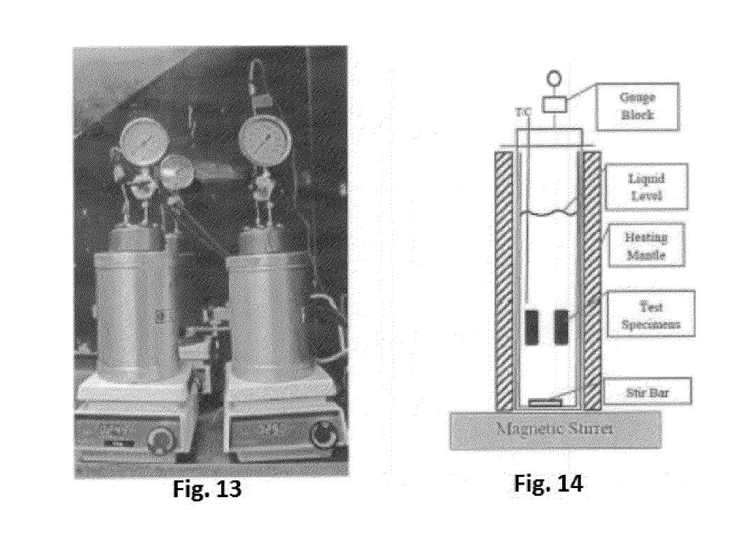

The corrosion test setup is shown in FIG. 13. Parr Instruments Series 4760 general purpose 600 ml bombs fitted with a gage block assembly were used for this test. A borosilicate glass liner was inserted to protect the walls of the pressure vessel from the test fluid. The test specimens were suspended in the fluids using PTFE string. A 1-inch long magnetic stir bar was placed in the bottom of each test vessel. The test vessels were fitted with a thermocouple that was immersed in the test fluid for temperature control. The vessels were assembled and purged with carbon dioxide for an additional 5 minutes. The assembled test vessels were placed in heating mantles on top of digitally controlled magnetic stirrers. The stirrers rotated at 250 rpm throughout the test. The test vessels were heated to 140° C. and the temperature was maintained for 1 week.

FIG. 9 shows the plates that had been exposed to pure oil; the test specimens appeared unaffected by the exposure. No visual changes were observed and mass loss was equal to or less than 0.2 mg which is less than the error of measurement. FIG. 10 shows the plates were exposed to the oil/water mix; both test specimens were discolored by the exposure. The dark colored film was tightly adherent and was not completely removed with aggressive cleaning using a soap and water paste and soft bristle brush. Each specimen lost approximately 20 mg in weight which calculates to a general corrosion rate of 5.2 mils per year (mpy, 1 mil=0.001-inch). FIG. 11 shows the plates exposed to the filtrate. The test specimens appeared unaffected by the exposure except for a few very small areas of discoloration. No other visual changes were observed and mass loss was equal to or less than 0.4 mg, which is the maximum error of measurement. Table 1 tabulates the results of the corrosion testing.

TABLE 1
Corrosion Rates

| Test Fluid | Test | Corrosion Rate | |
|---|---|---|---|
| Condition | Specimen ID | (mpy¹) | Comments |
| Pure Oil | ALP 14 | <0.1² | No Visible Attack |
| | ALP 15 | <0.1² | |
| Unfiltered | ALP 16 | 5.2 | General Corrosion |
| mixture | ALP 17 | 5.2 | |
| Filtered | ALP 18 | 0.1³ | Small areas of |
| mixture | ALP 19 | 0.1² | discoloration |

¹mpy = mils per year, 1 mil = 0.001-inch
²Mass loss less than the error of measurement.
³Mass loss equal to the error of measurement, 0.0004 grams.

As can be seen, filtering the oil/water mixture through the membrane according to the present invention removed enough water and particulate to protect the plates from corrosion better than those exposed to the unfiltered mixture.

What is claimed is:

1. A check valve for down-hole drilling applications comprising:
a. a housing having a vent port;
b. a chamber within said housing;
c. a displaceable member within said chamber; and
d. an expanded polytetrafluoroethylene (ePTFE) membrane disposed over said vent port to protect said check valve from corrosion.

2. The check valve of claim 1, wherein said ePTFE membrane is asymmetric.

3. The check valve of claim 1, wherein said ePTFE membrane comprises a first membrane layer and a second membrane layer, wherein one or more of the first and second membrane layers comprise ePTFE.

4. The check valve of claim 3, wherein said ePTFE membrane further comprises a support layer.

5. The check valve or claim 1, wherein said ePTFE membrane has a porosity that is sufficiently small so as to prevent water from passing through the ePTFE membrane.

6. The check valve of claim 1, wherein said ePTFE membrane has a porosity that is sufficiently small so as to prevent particulates from passing through the ePTFE membrane.

7. The check valve of claim 1, wherein said ePTFE membrane comprises a first membrane layer and a second membrane layer, wherein the first membrane layer has a porosity that is larger than the porosity of the second membrane layer.

8. The check valve of claim 7, wherein the first membrane layer has a bubble point of between approximately 20 psi and approximately 80 psi.

9. The check valve of claim 7, wherein the second membrane layer has a bubble point of between approximately 3 psi and approximately 10 psi.

10. An electric submersible pump for down-hole drilling applications comprising a protector section having a check valve comprising:
a. a housing having a vent port;
b. a chamber within said housing;
c. a displaceable member within said chamber; and
d. an expanded polytetrafluoroethylene (ePTFE) membrane disposed over said vent port to protect said check valve from corrosion.

11. A method of protecting from corrosion in a down-hole drilling application a check valve having a housing having a vent port, a chamber within the housing, and a displaceable member within the chamber, the method comprising disposing over said vent port an asymmetric expanded polytetrafluoroethylene (ePTFE) membrane.

12. A method of equalizing pressure between two liquid media at high hydrostatic pressure comprising the step of disposing an expanded polytetrafluoroethylene (ePTFE) membrane between said liquids.

13. A vent port cap comprising:
a base and a filter membrane, the filter membrane comprising an expanded polytetrafluoroethylene (ePTFE) membrane having a porosity that is sufficiently small so as to prevent water and particulates from passing through the filter membrane.

14. The vent port cap of claim 13, wherein the filter membrane comprises a first filter layer having a first porosity and a second filter layer having a second porosity, wherein the first porosity is different from the second porosity.
